(19) United States
(12) Patent Application Publication
(10) Pub. No.: US 2023/0352005 A1
(43) Pub. Date: Nov. 2, 2023

(54) SERVER DEVICE, CONFERENCE ASSISTING SYSTEM, CONFERENCE ASSISTING METHOD, AND NON-TRANSITORY COMPUTER READABLE STORAGE MEDIUM

(71) Applicant: NEC Corporation, Minato-ku, Tokyo (JP)

(72) Inventors: Momone AKAHORI, Tokyo (JP); Takuya SERA, Tokyo (JP)

(73) Assignee: NEC Corporation, Minato-ku, Tokyo (JP)

(21) Appl. No.: 17/797,964

(22) PCT Filed: Feb. 28, 2020
(86) PCT No.: PCT/JP2020/008497

§ 371 Date: Aug. 5, 2022

(51) Int. Cl. G10L 15/08; G10L 25/63; H04L 12/18

(52) U.S. Cl. CPC G10L 15/08; G10L 25/63; H04L 12/1831; G10L 2015/088

(57) ABSTRACT

Provided is a server device that assists with a conference to allow for constructive discussions. This server device comprises a storage unit and an environment control unit. The storage unit stores therein a learning model generated using words uttered in conferences and room environments that cause speakers of the uttered words to have a specific feeling. The environment control unit determines a suitable room environment for a user by inputting, to the learning model, a word uttered by the user, and controls a room environment changing device to change the room environment to the determined room environment.

### TECHNICAL FIELD

The present invention relates to a server device, a conference assisting system, a conference assisting method, and a program.

### BACKGROUND ART

Conferences, meetings, and the like in corporate activities and the like are important places for decision making. Various proposals have been made to efficiently hold conferences.

For example, PTL 1 describes that content of a conference is capitalized to improve efficiency of conference operation. The conference assisting system disclosed in PTL 1 includes an image recognition unit. The image recognition unit recognizes an image related to each attendee from video data acquired by a video conference apparatus by an image recognition technology. Furthermore, the system includes a voice recognition unit. The voice recognition unit acquires voice data of each participant acquired by the video conference apparatus, and compares the voice data with feature information of the voice of each participant registered in advance. Furthermore, the voice recognition unit specifies speakers of each statement in the voice data based on the movement information of each attendee. Furthermore, the conference assisting system includes a timeline management unit that outputs, as a timeline, voice data of each of the participants acquired by the voice recognition unit in a time series of statements.

### CITATION LIST

### Patent Literature

[PTL 1] JP 2019-061594 A

### SUMMARY OF INVENTION

### Technical Problem

There are cases where a discussion becomes active d at a conference and not all participants can have a discussion in a calm manner. Alternatively, each participant may be passive in the discussion and the conference may stagnate. In either case, it cannot be said that constructive discussion is being conducted.

It is a main object of the present invention to provide a server device, a conference assisting system, a conference assisting method, and a program that contribute to assisting with a conference so that constructive discussion is performed.

### Solution to Problem

According to a first aspect of the present invention, there is provided a server device including a storage unit that stores a learning model generated by using a word uttered at a conference and a room environment that causes a speaker of the uttered word to have a specific feeling, and an environment control unit that determines a room environment suitable for a user by inputting a word uttered by the user to the learning model and controls a room environment changing device to change the room environment to the determined room environment.

According to a second aspect of the present invention, there is provided a conference assisting system including a room environment changing device configured to change a room environment and a server device connected to the room environment changing device, in which the server device includes a storage unit that stores a learning model generated by using a word uttered at a conference and a room environment that causes a speaker of the uttered word to have a specific feeling, and an environment control unit that determines a room environment suitable for a user by inputting a word uttered by the user to the learning model and controls the room environment changing device to change the room environment to the determined room environment.

According to a third aspect of the present invention, there is provided a conference assisting method performed by a server device, the method including storing a learning model generated by using a word uttered at a conference and a room environment that causes a speaker of the uttered word to have a specific feeling, and determining a room environment suitable for a user by inputting a word uttered by the user to the learning model and controlling a room environment changing device to change the room environment to the determined room environment.

According to a fourth aspect of the present invention, there is provided a computer readable storage medium that stores a program for causing a computer mounted on a server device to execute:
a process for storing a learning model generated by using a word uttered at a conference and a room environment that causes a speaker of the uttered word to have a specific feeling, and a process for determining a room environment suitable for a user by inputting a word uttered by the user to the learning model and controlling a room environment changing device to change the determined room environment.

### Advantageous Effects of Invention

According to each aspect of the present invention, there are provided a server device, a conference assisting system, a conference assisting method, and a program that contribute to assisting with a conference so that constructive discussion is performed. The effects of the present invention are not limited to the above. According to the present invention, other effects may be exhibited instead of or in addition to the above effect.

### BRIEF DESCRIPTION OF DRAWINGS

FIG. 1 is a diagram for illustrating an outline of an example embodiment.

FIG. 2 is a diagram illustrating an example of a schematic configuration of a conference assisting system according to a first example embodiment.

FIG. 3 is a diagram for illustrating connection between a server device and a conference room according to the first example embodiment.

FIG. 4 is a diagram illustrating an example of a processing configuration of a server device according to the first example embodiment.

FIG. 5 is a diagram illustrating an example of a processing configuration of a user registration unit according to the first example embodiment.

FIG. 6 is a diagram for illustrating an operation of a user information acquiring unit according to the first example embodiment.

FIG. 7 is a diagram illustrating an example of a user database.

FIG. 8 is a diagram illustrating an example of a participant list.

FIG. 9 is a diagram illustrating an example of a processing configuration of a conference minutes generation unit according to the first example embodiment.

FIG. 10 is a diagram illustrating an example of conference minutes.

FIG. 11 is a diagram illustrating an example of a processing configuration of a conference room terminal according to the first example embodiment.

FIG. 12 is a diagram illustrating an example of a processing configuration of a room environment changing device according to the first example embodiment.

FIG. 13 is a diagram illustrating an example of table information showing the relationship between a type of scent and a tank containing a scent.

FIG. 14 is a sequence diagram illustrating an example of operation of a conference assisting system according to the first example embodiment.

FIG. 15 is a diagram illustrating an example of a schematic configuration of a conference assisting system according to a second example embodiment.

FIG. 16 is a diagram illustrating an example of a processing configuration of a server device according to the second example embodiment.

FIG. 17 is a diagram for illustrating generation of a learning model according to the second example embodiment.

FIG. 18 is a diagram for illustrating generation of the learning model according to the second example embodiment.

FIG. 19 is a diagram illustrating an example of a processing configuration of a room environment changing device according to the second example embodiment.

FIG. 20 is a sequence diagram illustrating an example of operation of a conference assisting system according to the second example embodiment.

FIG. 21 is a diagram illustrating an example of a hardware configuration of a server device.

FIG. 22 is a diagram illustrating an example of a schematic configuration of a conference assisting system according to a modification example of the present disclosure.

FIG. 23 is a diagram illustrating an example of a schematic configuration of the conference assisting system according to the modification example of the present disclosure.

### EXAMPLE EMBODIMENT

First, an outline of an example embodiment will be described. The reference numerals in the drawings attached to this outline are attached to each element for convenience as an example for assisting with understanding, and the description of this outline is not intended to be limiting in any way. In addition, in a case where there is no particular explanation, the block illustrated in each drawing represents not a configuration of a hardware unit but a configuration of a functional unit. Connection lines between blocks in each drawing include both bidirectional and unidirectional lines. A unidirectional arrow schematically indicates a flow of a main signal (data), and does not exclude bidirectionality. In the present specification and the drawings, elements that can be similarly described are denoted by the same reference numerals, and redundant description can be omitted.

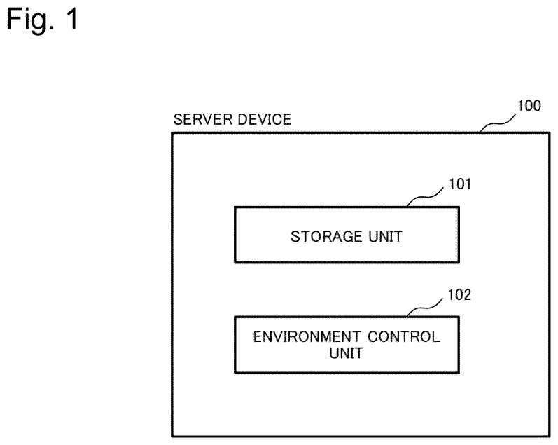

A server device 100 according to one example embodiment includes a storage unit 101 and an environment control unit 102 (see FIG. 1). The storage unit 101 stores therein a learning model generated using words uttered in conferences and room environments that cause speakers of the uttered words to have a specific feeling. The environment control unit 102 determines a suitable room environment for a user by inputting, to the learning model, a word uttered by the user, and controls a room environment changing device to change the room environment to the determined room environment.

In a long conference, discussion may stagnant. When the discussion stagnates, the conference is appropriately interrupted, and each participant takes a break. The server device 100 controls the environment in the room (for example, a break room) so that the concentration and the creativity of the participants are improved when the conference is resumed. For example, a server device 20 improves the concentration and the creativity of a person on break by a room environment (for example, scent) that matches the features (personality, way of thinking) of each person on break.

As a result of intensive studies, the inventors have found that there is a predetermined relationship between a human feature (personality, way of thinking), and a change in feeling and emotion felt by a person with respect to a scent. For example, they found that the concentration tends to increase when a positive person sniffs a scent A, and the concentration tends to increase when a negative person sniffs a scent B. Therefore, the server device 100 learns a relationship between a word (a word that shows the features of positive people or a word that shows the features of negative people) that briefly represents a feature of a person and a “scent” that gives each person has a predetermined emotion, and generates a learning model.

The server device 100 inputs a word uttered by the person on break (a word frequently uttered by the person on break) to the learning model prepared as described above, and selects a scent suitable for the person on break. The room is filled with the selected scent by the room environment changing device. As a result, the person on break can improve his/her concentration and creativity, and a naturally active discussion is held in a conference resumed after the break.

Hereinafter, specific example embodiments will be described in more detail with reference to the drawings.

### First Example Embodiment

A first example embodiment will be described in more detail with reference to the drawings.

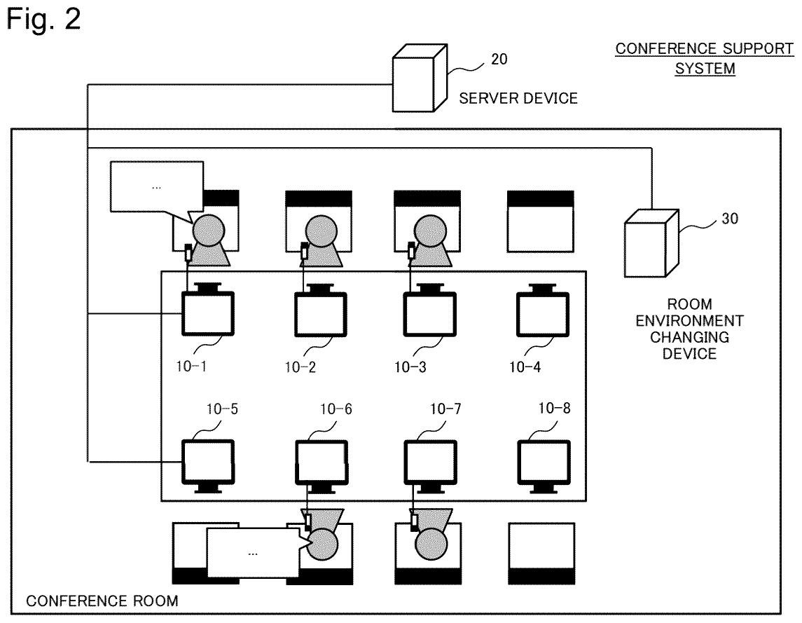

FIG. 2 is a diagram illustrating an example of a schematic configuration of a conference assisting system according to the first example embodiment. Referring to FIG. 2, the conference assisting system includes a plurality of conference room terminals 10-1 to 10-8, the server device 20, and a room environment changing device 30. It goes without saying that the configuration illustrated in FIG. 2 is an example and is not intended to limit the number of conference room terminals 10 and the like. Furthermore, in the following description, in a case where there is no particular reason to distinguish the conference room terminals 10-1 to 10-8, they are simply referred to as “conference room terminals 10”.

Each of the plurality of conference room terminals 10 and the server device 20 are connected by wired or wireless communication means, and are configured to be able to communicate with each other. Similarly, the room environment changing device 30 and the server device are connected by wired or wireless communication means and are configured to be able to communicate with each other. The server device may be installed in the same room or building as the conference room, or may be installed on a network (on a cloud).

The conference room terminal 10 is a terminal installed in each seat of the conference room. The participant operates the terminal to perform the conference while displaying necessary information and the like. The conference room terminal 10 has a camera function and is configured to be able to image a participant who is seated. Further, the conference room terminal 10 is configured to be connectable to a microphone (for example, a pin microphone or a wireless microphone). A voice of a participant seated in front of each of the conference room terminals 10 is collected by the microphone. The microphone connected to the conference room terminal 10 is desirably a microphone with strong directivity. This is because it is only necessary to collect the voice of the user wearing the microphone, and it is not necessary to collect the voice of another person.

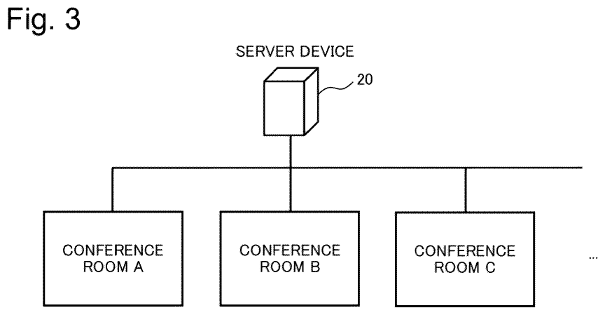

The server device 20 is a device that assists with a conference. The server device 20 assists with a conference which is a place for decision making and a place for idea generation. The server device 20 collects voices of the participants and generates simple conference minutes. The server device 20 estimates the “situation of the conference” by analyzing the generated conference minutes. Specifically, the server device 20 estimates a situation such as whether the conference is heated or the conference is stagnant. The server device changes (controls) the environment of the conference room based on the estimated situation of the conference. As illustrated in FIG. 3, the server device 20 assists with a conference held in at least one or more conference rooms.

The room environment changing device 30 is a device for changing the environment of the conference room. The room environment changing device 30 changes the environment of the conference room based on an instruction from the server device 20. For example, the room environment changing device 30 changes the “scent” to be generated. Alternatively, the room environment changing device 30 changes “brightness” in the conference room. Alternatively, the room environment changing device 30 may change “sound (music)” to be played in the conference room.

The room environment changing device 30 changes the environment in the conference room by optional means and methods. In the first example embodiment, a case where the room environment changing device 30 changes the “scent (smell)” of the conference room will be described. However, the aspect of the environment changed by the room environment changing device 30 is not limited to the “scent” as described above.

<Schematic Operation of System>

The server device 20 collects voices of the participants and extracts keywords included in the collected voices. The server device 20 generates simple conference minutes of the conference in real time by storing the participant and the keyword uttered by the participant in association with each other.

The server device 20 estimates the situation (state) of the conference in parallel with the generation of the conference minutes. Specifically, the server device 20 calculates an index indicating the situation of the conference. For example, the server device 20 calculates a conference success degree indicating a success degree of a conference. Details of the conference success degree will be described later.

For example, in a case where it is determined that the conference is overheated based on the calculated conference success degree, the server device 20 controls the room environment to cause the participants to regain composure. On the other hand, in a case where it is determined that the conference is stagnant based on the calculated conference success degree, the server device 20 controls the room environment so that the conference becomes activated.

<Prior Preparation>

Here, in order to achieve conference assistance by the server device 20, a system user (a user scheduled to participate in the conference) needs to make a prior preparation. The prior preparation will be described below.

The user registers his/her biometric information, profile, and the like in the system. Specifically, the user inputs a face image to the server device 20. In addition, the user inputs his/her profile (for example, information such as a name, an employee number, a work location, a department, a position, or contact information) to the server device 20.

Any method can be used to input information such as the biometric information and the profile. For example, the user captures his/her face image using a terminal such as a smartphone. Further, the user generates a text file or the like in which the profile is described using the terminal. The user operates the terminal to transmit the information (face image and profile) to the server device 20. Alternatively, the user may input necessary information to the server device 20 using an external storage device such as a Universal Serial Bus (USB) in which the information is stored.

Alternatively, the server device 20 may have a function as a Web server, and the user may input necessary information in a form provided by the server. Alternatively, a terminal for inputting the information may be installed in each conference room, and the user may input necessary information to the server device 20 from the terminal installed in the conference room.

The server device 20 updates a database (DB) for managing system users using the acquired user information (biometric information, profile, or the like). Details regarding the update of the database will be described later, but the server device 20 roughly updates the database through the following operation. In the following description, a database for managing users using the system of the present disclosure will be referred to as a “user database”.

In a case where the person relating to the acquired user information is a new user not registered in the user database, the server device 20 assigns an identifier (ID) to the user. In addition, the server device 20 generates a feature amount that characterizes the acquired face image.

The server device 20 adds an entry including the ID assigned to the new user, the feature amount generated from the face image, the face image of the user, the profile, and the like to the user database. When the server device 20 registers the user information, the participants in the conference can use the conference assisting system illustrated in FIG. 2.

Next, details of each device included in the conference assisting system according to the first example embodiment will be described.

[Server Device]

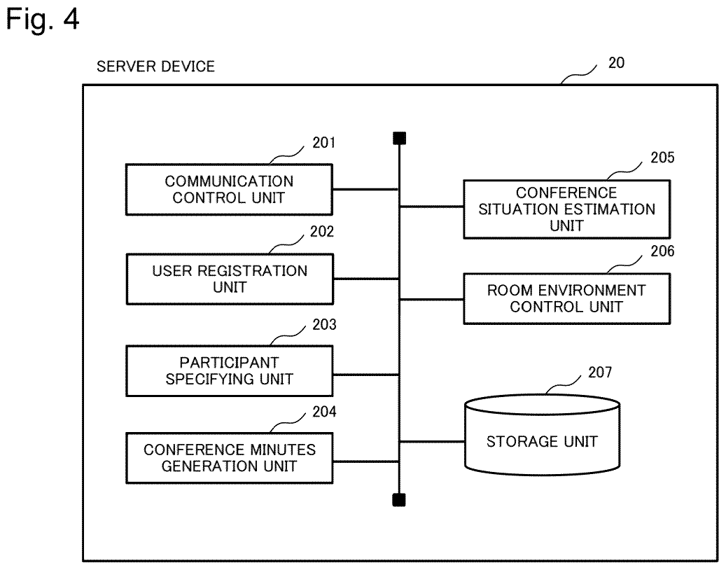

FIG. 4 is a diagram illustrating an example of a processing configuration (processing module) of the server device 20 according to the first example embodiment. Referring to FIG. 4, the server device 20 includes a communication control unit 201, a user registration unit 202, a participant specifying unit 203, a conference minutes generation unit 204, a conference situation estimation unit 205, a room environment control unit 206, and a storage unit 207.

The communication control unit 201 is means configured to control communication with other devices. Specifically, the communication control unit 201 receives data (packets) from the conference room terminal 10 and the room environment changing device 30. In addition, the communication control unit 201 transmits data to the conference room terminal 10 and the room environment changing device 30. The communication control unit 201 delivers data received from another device to another processing module. The communication control unit 201 transmits data acquired from another processing module to another device. In this manner, the other processing modules transmit and receive data to and from other devices via the communication control unit 201.

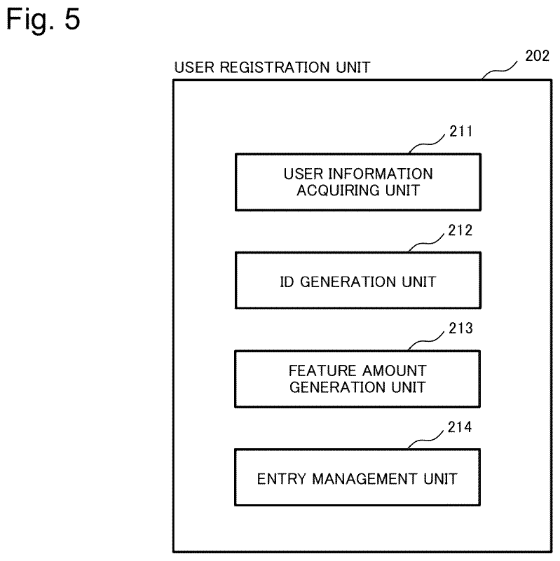

The user registration unit 202 is means configured to achieve the system user registration described above. The user registration unit 202 includes a plurality of submodules. FIG. 5 is a diagram illustrating an example of a processing configuration of the user registration unit 202. Referring to FIG. 5, the user registration unit 202 includes a user information acquiring unit 211, an ID generation unit 212, a feature amount generation unit 213, and an entry management unit 214.

The user information acquiring unit 211 is means configured to acquire the user information described above. The user information acquiring unit 211 acquires biometric information (a face image) and a profile (name, affiliation, or the like) of the system user. The system user may input the information from his/her terminal to the server device 20, or may directly operate the server device 20 to input the information.

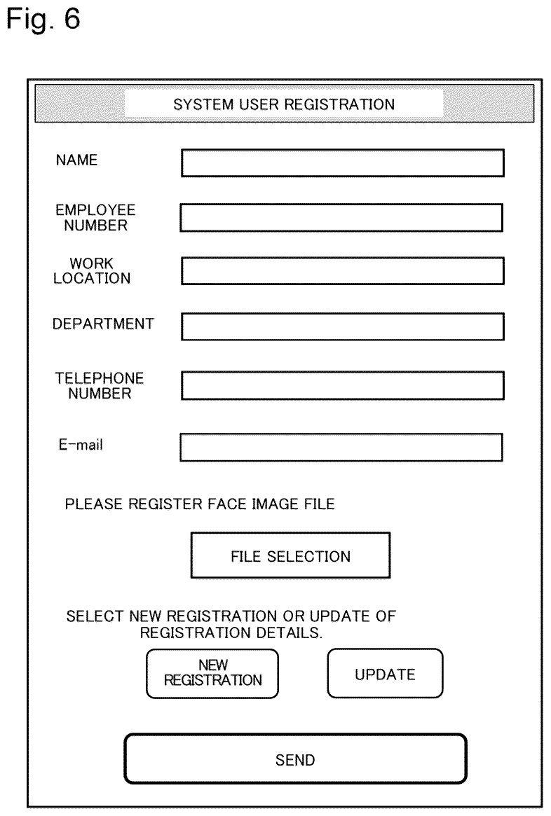

The user information acquiring unit 211 may provide a graphical user interface (GUI) or a form for inputting the information. For example, the user information acquiring unit 211 displays an information input form as illustrated in FIG. 6 on the terminal operated by the user.

The system user inputs the information illustrated in FIG. 6. In addition, the system user selects whether to newly register the user in the system or to update the already registered information. After inputting all the information items, the system user presses the “send” button, and inputs the biometric information and the profile to the server device 20.

The user information acquiring unit 211 stores the acquired user information in the storage unit 207.

The ID generation unit 212 is means configured to generate an ID to be assigned to the system user. In a case where the user information input by the system user is information related to new registration, the ID generation unit 212 generates an ID for identifying the new user. For example, the ID generation unit 212 may calculate a hash value of the acquired user information (face image and profile) and use the hash value as an ID to be assigned to the user. Alternatively, the ID generation unit 212 may assign a unique value each time user registration is performed and use the assigned value as the ID. In the following description, an ID (an ID for identifying a system user) generated by the ID generation unit 212 is referred to as a “user ID”.

The feature amount generation unit 213 is means configured to generate a feature amount (a feature vector including a plurality of feature amounts) characterizing the face image from the face image included in the user information. Specifically, the feature amount generation unit 213 extracts feature points from the acquired face image. Since existing techniques can be used for the feature point extraction processing, detailed description thereof will be omitted. For example, the feature amount generation unit 213 extracts eyes, a nose, a mouth, and the like as feature points from the face image. Thereafter, the feature amount generation unit 213 calculates the position of each feature point and the distances between the feature points as feature amounts, and generates a feature vector (vector information characterizing the face image) including a plurality of feature amounts.

The entry management unit 214 is means configured to manage an entry of the user database. When registering a new user in the database, the entry management unit 214 adds an entry including the user ID generated by the ID generation unit 212, the feature amount generated by the feature amount generation unit 213, the face image, and the profile acquired from the user to the user database.

In a case where the information of the user already registered in the user database is updated, the entry management unit 214 specifies an entry to be subjected to the information update based on the employee number or the like, and updates the user database using the acquired user information. At that time, the entry management unit 214 may update a difference between the acquired user information and the information registered in the database, or may overwrite each item of the database with the acquired user information. Similarly, regarding the feature amount, the entry management unit 214 may update the database in a case where there is a difference in the generated feature amount, or may overwrite the existing feature amount with the newly generated feature amount.

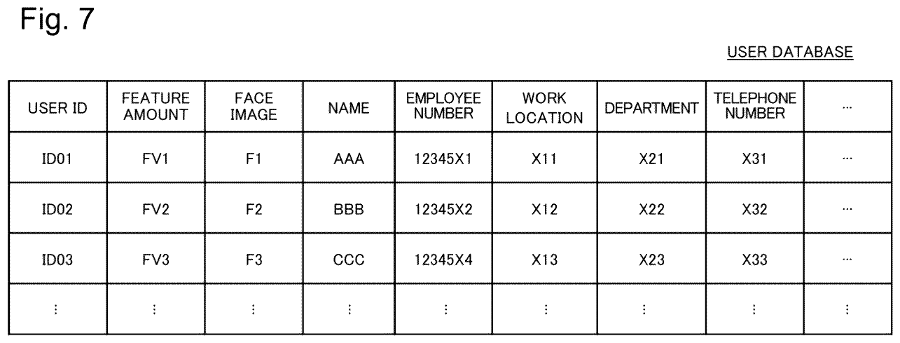

The user registration unit 202 operates to construct a user database as illustrated in FIG. 7. It goes without saying that the content registered in the user database illustrated in FIG. 7 is an example and is not intended to limit the information registered in the user database. For example, the “face image” may not be registered in the user database as necessary.

The description will now return to FIG. 4. The participant specifying unit 203 is means configured to specify a participant participating in the conference (a user who has entered the conference room among users registered in the system). The participant specifying unit 203 acquires a face image from the conference room terminal 10 at which the participant is seated among the conference room terminals 10 installed in the conference room. The participant specifying unit 203 calculates a feature amount from the acquired face image.

The participant specifying unit 203 sets the feature amount calculated based on the face image acquired from the conference room terminal 10 as a matching target, and performs matching processing with the feature amount registered in the user database. More specifically, the participant specifying unit 203 sets the calculated feature amount (feature vector) as a matching target, and executes one-to-N(N is a positive integer, and the same applies hereinafter) matching with a plurality of feature vectors registered in the user database.

The participant specifying unit 203 calculates similarity between the feature amount of the matching target and each of the plurality of feature amounts on the registration side. A chi-square distance, a Euclidean distance, or the like can be used as the similarity. The similarity is lower as the distance is longer, and the similarity is higher as the distance is shorter.

The participant specifying unit 203 specifies a feature amount having a similarity with the feature amount of the matching target equal to or greater than a predetermined value and having the highest similarity among the plurality of feature amounts registered in the user database.

The participant specifying unit 203 reads the user ID relating to the feature amount obtained as a result of the one-to-N matching from the user database.

The participant specifying unit 203 repeats the above-described processing for the face image acquired from each of the conference room terminals 10 and specifies the user ID relating to each face image. The participant specifying unit 203 generates a participant list by associating the specified user ID with the ID of the conference room terminal 10 which is the transmission source of the face image. As the ID of the conference room terminal 10, a media access control (MAC) address or an Internet protocol (IP) address of the conference room terminal 10 can be used.

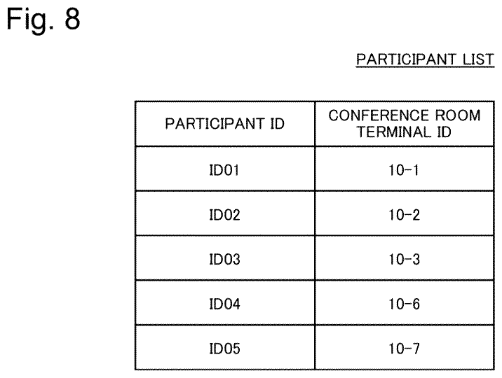

For example, in the example of FIG. 2, a participant list as illustrated in FIG. 8 is generated. In FIG. 8, for easy understanding, reference numerals assigned to the conference room terminal 10 are described as conference room terminal IDs. The “participant ID” included in the participant list is a user ID registered in the user database.

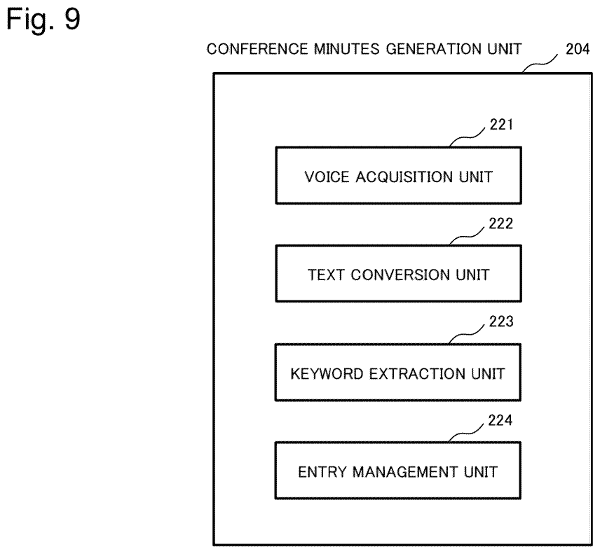

The conference minutes generation unit 204 is means configured to collect voices of participants and generate conference minutes (simple conference minutes). The conference minutes generation unit 204 includes a plurality of submodules. FIG. 9 is a diagram illustrating an example of a processing configuration of the conference minutes generation unit 204. Referring to FIG. 9, the conference minutes generation unit 204 includes a voice acquisition unit 221, a text conversion unit 222, a keyword extraction unit 223, and an entry management unit 224.

The voice acquisition unit 221 is means configured to acquire the voice of the participant from the conference room terminal 10. The conference room terminal 10 generates a voice file each time a participant makes an utterance and transmits the voice file to the server device 20 together with an ID (conference room terminal ID) of the host device. The voice acquisition unit 221 refers to the participant list and identifies a participant ID relating to the acquired conference room terminal ID. The voice acquisition unit 221 delivers the identified participant ID and the voice file acquired from the conference room terminal 10 to the text conversion unit 222.

The text conversion unit 222 is means configured to convert the acquired voice file into text. The text conversion unit 222 converts the content recorded in the voice file into text using a voice recognition technology. Since the text conversion unit 222 can use an existing voice recognition technology, detailed description thereof is omitted, but the text conversion unit generally operates as follows.

The text conversion unit 222 performs filter processing for removing noise and the like from the voice file. Next, the text conversion unit 222 specifies phonemes from the sound wave of the voice file. A phoneme is the smallest constituent unit of a language. The text conversion unit 222 specifies a sequence of phonemes and converts the sequence into a word. The text conversion unit 222 creates a sentence from the sequence of words and outputs a text file. At the time of the filter processing, since the voice smaller than the predetermined level is deleted, even in a case where the voice of the neighbor is included in the voice file, the text file is not generated from the voice of the neighbor.

The text conversion unit 222 delivers the participant ID and the text file to the keyword extraction unit 223.

The keyword extraction unit 223 is means configured to extract a keyword from the text file. For example, the keyword extraction unit 223 refers to an extraction keyword list in which keywords to be extracted are described in advance, and extracts the keywords described in the list from the text file. Alternatively, the keyword extraction unit 223 may extract a noun included in the text file as a keyword.

For example, a case where a participant makes an utterance that “AI is becoming more and more important technology” will be considered. In this case, if the word “AI” is registered in the extraction keyword list, the word “AI” is extracted from the above utterance. Alternatively, in a case where nouns are extracted, the word “AI” and the word “technology” are extracted. An existing part-of-speech decomposition tool (app) or the like may be used to extract nouns.

The keyword extraction unit 223 delivers the participant ID and the extracted keyword to the entry management unit 224.

The conference minutes generation unit 204 generates conference minutes in a table format (the conference minutes in which at least the speaker (participant ID) and the content of the utterance (keyword) are included in one entry).

The entry management unit 224 is means configured to manage entries of the conference minutes. The entry management unit 224 generates the conference minutes for each conference being held. Upon detecting the start of the conference, the entry management unit 224 generates new conference minutes. For example, the entry management unit 224 may acquire an explicit notification of the start of the conference from the participant and detect the start of the conference, or may detect the start of the conference when the participant makes an utterance for the first time.

Upon detecting the start of the conference, the entry management unit 224 generates an ID (hereinafter, referred to as a conference ID) for identifying the conference, and manages the ID in association with the conference minutes. The entry management unit 224 can generate the conference ID by using the room number of the conference room, the date and time of the conference, and the like. Specifically, the entry management unit 224 can generate the conference ID by concatenating the above information and calculating a hash value. By managing the participant list and the conference ID in association with each other, it is possible to determine which conference ID the voice of the participant associated to.

The entry management unit 224 adds the utterance time, the participant ID, and the extracted keyword to the conference minutes in association with each other. The utterance time may be a time managed by the server device 20 or a time when a voice is acquired from the conference room terminal 10.

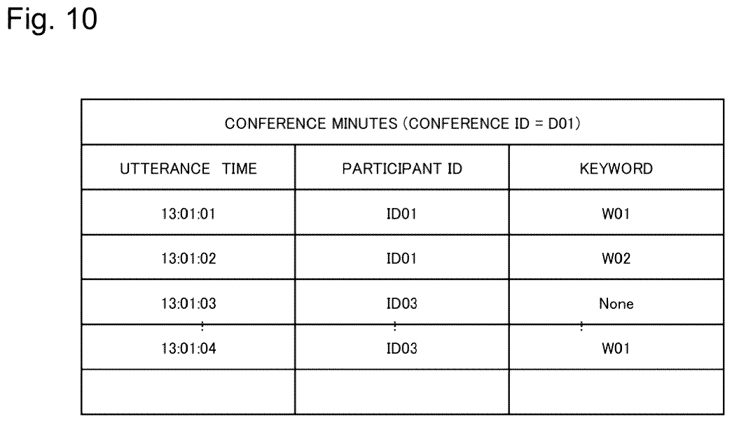

FIG. 10 is a diagram illustrating an example of the conference minutes. As illustrated in FIG. 10, the entry management unit 224 adds the keyword uttered by the participant to the conference minutes together with the participant ID each time the voice of the participant is acquired. In a case where the keyword cannot be extracted from the utterance of the participant, the entry management unit 224 clearly indicates the absence of the keyword by setting “None” or the like in the field of the keyword. Alternatively, in a case where a plurality of keywords is found in one utterance, the entry management unit 224 may divide the entry to be registered, or may describe a plurality of keywords in one entry.

The generation of the conference minutes by the conference minutes generation unit 204 is exemplary and is not intended to limit a method of generating the conference minutes or the generated conference minutes. For example, the conference minutes generation unit 204 may generate, as conference minutes, information in which speakers are associated with contents of remarks themselves (text files relating to the utterance).

The description will now return to FIG. 4. The conference situation estimation unit 205 is means configured to estimate a situation of the conference. The conference situation estimation unit 205 calculates the above-described conference success degree. Specifically, the conference situation estimation unit 205 analyzes the conference minutes generated by the conference minutes generation unit 204 and calculates the conference success degree.

For example, the conference situation estimation unit 205 generates the number of times of utterances in a predetermined period as the conference success degree. Specifically, the conference situation estimation unit 205 counts the number of times (the number of entries) of utterance between the current time and a predetermined time before. At that time, the conference situation estimation unit 205 may count all the number of times of utterances in the predetermined period, or may count the number of times of utterances including a keyword.

Alternatively, the conference situation estimation unit 205 may generate the number of speakers in a predetermined period as the conference success degree. In this case, the conference situation estimation unit 205 calculates the conference success degree by counting the number of each participant ID in a predetermined period.

Alternatively, the conference situation estimation unit 205 may calculate the conference success degree based on the number of times of utterances and the number of speakers in a predetermined period. For example, the conference situation estimation unit 205 may multiply the number of times of utterances in a predetermined period by the number of speakers and set the result as the conference success degree. That is, the conference situation estimation unit 205 may calculate the conference success degree based on two or more parameters (number of utterances and number of speakers).

Alternatively, the conference situation estimation unit 205 may calculate the conference success degree based on an interval from an utterance of a certain participant to an utterance of another participant. At that time, the conference situation estimation unit 205 determines that the silence of the conference is long if the utterance interval is long and sets the conference success degree to be low. On the other hand, the conference situation estimation unit 205 determines that the discussion is actively performed when the interval of the utterance is short and sets the conference success degree to be high. For example, the conference situation estimation unit 205 calculates the conference success degree by calculating the reciprocal of the utterance interval.

Alternatively, the conference situation estimation unit 205 may perform statistical processing on the conference success degree calculated by a different method and set the result as the final “conference success degree”. For example, the conference situation estimation unit 205 may calculate the conference success degree based on a first conference success degree calculated from the number of times of utterances in a predetermined period, a second conference success degree calculated from the number of speakers in the predetermined period, and a third conference success degree calculated based on the utterance interval. For example, the conference situation estimation unit 205 may set the total of the three conference success degrees as the final conference success degree, or may set the average value of the three success degrees as the final conference success degree. Alternatively, the conference situation estimation unit 205 may calculate a weighted average value obtained by setting a weight for each of the three conference success degrees as the conference success degree. In this manner, the conference situation estimation unit 205 may perform statistical processing on the conference success degree calculated by a different method and estimate the situation of the conference based on a result of the statistical processing.

The conference success degree calculated by the method as described above indicates that the conference is stagnant when the value is small, and indicates that the discussion is actively performed when the value is large. For example, a situation in which the number of times of utterances in the entire conference is small, only specific participants are uttered, or the time during which the participants are silent is long indicates a situation in which the conference is stagnant. In this manner, the conference situation estimation unit 205 calculates the conference success degree based on at least one or more parameters included in the conference minutes.

The conference situation estimation unit 205 estimates the situation (state) of the conference based on the generated conference success degree. For example, the conference situation estimation unit 205 executes threshold value processing on the conference success degree and estimates the situation of the conference based on the result.

For example, a case where the situation of the conference is classified into three categories of “stagnation”, “normal”, and “overheating” will be considered. In this case, the conference situation estimation unit 205 sets the situation of the conference to “stagnation” if the conference success degree is smaller than the first threshold value. The conference situation estimation unit 205 sets the situation of the conference to “normal” if the conference success degree is equal to or greater than the first threshold value and smaller than the second threshold value. The conference situation estimation unit 205 sets the situation of the conference to “overheating” if the conference success degree is equal to or greater than the second threshold value.

The conference situation estimation unit 205 notifies the room environment control unit 206 of the estimated situation of the conference (for example, stagnation, normal, and overheating).

The room environment control unit 206 is means configured to control the room environment (the environment of the conference room) based on the conference situation estimated by the conference situation estimation unit 205. Specifically, in a case where the room environment control unit 206 determines that it is necessary to change the environment of the conference room based on the estimated conference situation, the room environment control unit transmits a “room environment changing instruction” to the room environment changing device 30.

For example, if the conference situation is “stagnation”, the room environment control unit 206 instructs the room environment changing device 30 to generate a “first scent”. Alternatively, if the conference situation is “overheating”, the room environment control unit 206 instructs the room environment changing device 30 to generate a “second scent”.

For example, as the first scent, a scent that makes the participants active is selected. In addition, as the second scent, a scent that makes the participant to regain composure is selected. It is desirable that the first and second scents are determined by repeating many trials and errors.

The “room environment” controlled by the room environment control unit 206 may be not only the environment of the entire conference room but also an environment in a range that can be felt for each participant. That is, the room environment may be, for example, an environment in a certain range in which an odor can be felt when an aroma is sprayed.

The storage unit 207 is means configured to store information necessary for the operation of the server device 20.

[Conference Room Terminal]

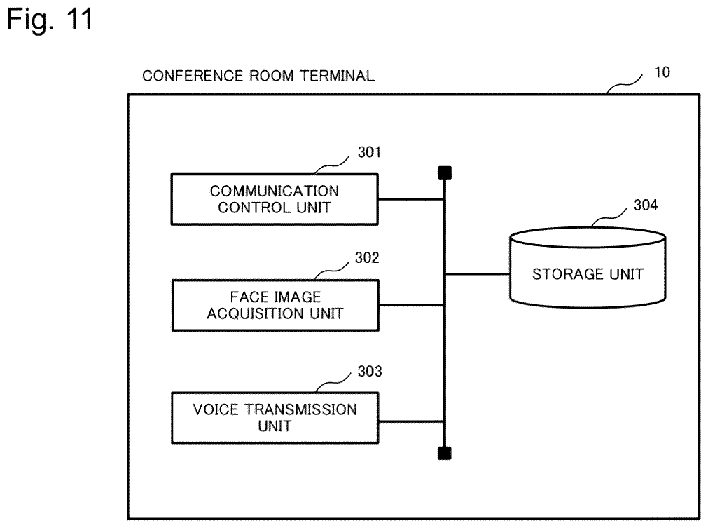

FIG. 11 is a diagram illustrating an example of a processing configuration (processing module) of the conference room terminal 10. Referring to FIG. 11, the conference room terminal 10 includes a communication control unit 301, a face image acquisition unit 302, a voice transmission unit 303, and a storage unit 304.

The communication control unit 301 is means configured to control communication with other devices. Specifically, the communication control unit 301 receives data (packet) from the server device 20. Furthermore, the communication control unit 301 transmits data to the server device 20. The communication control unit 301 delivers data received from another device to another processing module. The communication control unit 301 transmits data acquired from another processing module to another device. In this manner, the other processing modules transmit and receive data to and from other devices via the communication control unit 301.

The face image acquisition unit 302 is means configured to control a camera device and acquire a face image (biometric information) of a participant seated in front of the host device. The face image acquisition unit 302 images the front of the host device periodically or at a predetermined timing. The face image acquisition unit 302 determines whether a face image of a person is included in the acquired image, and extracts the face image from the acquired image data when the face image is included. The face image acquisition unit 302 transmits a set of the extracted face image and the ID (conference room terminal ID; for example, the IP address) of the host device to the server device 20.

Since an existing technology can be used for the face image detection processing and the face image extraction processing by the face image acquisition unit 302, detailed description thereof will be omitted. For example, the face image acquisition unit 302 may extract a face image (face area) from image data by using a learning model learned by a convolutional neural network (CNN). Alternatively, the face image acquisition unit 302 may extract the face image using a method such as template matching.

The voice transmission unit 303 is means configured to acquire the voice of the participant and transmit the acquired voice to the server device 20. The voice transmission unit 303 acquires a voice file related to a voice collected by a microphone (for example, a pin microphone). For example, the voice transmission unit 303 acquires a voice file encoded in a format such as a waveform audio file (WAV file).

The voice transmission unit 303 analyzes the acquired voice file, and in a case where the voice file includes a voice section (non-silence section; the utterance of the participant), the voice transmission unit 303 transmits the voice file including the voice section to the server device 20. At that time, the voice transmission unit 303 transmits the voice file and the ID (conference room terminal ID) of the host device to the server device 20.

Alternatively, the voice transmission unit 303 may attach the conference room terminal ID to the voice file acquired from the microphone and transmit the voice file as it is to the server device 20. In this case, the voice file acquired by the server device 20 may be analyzed to extract the voice file including the voice.

The voice transmission unit 303 extracts the voice file (a non-silent voice file) including the utterance of the participant using the existing “voice detection technology”. For example, the voice transmission unit 303 detects the voice by using a voice parameter sequence modeled by the Hidden Markov Model (HMM).

The storage unit 304 is means configured to store information necessary for the operation of the conference room terminal 10.

[Room Environment Changing Device]

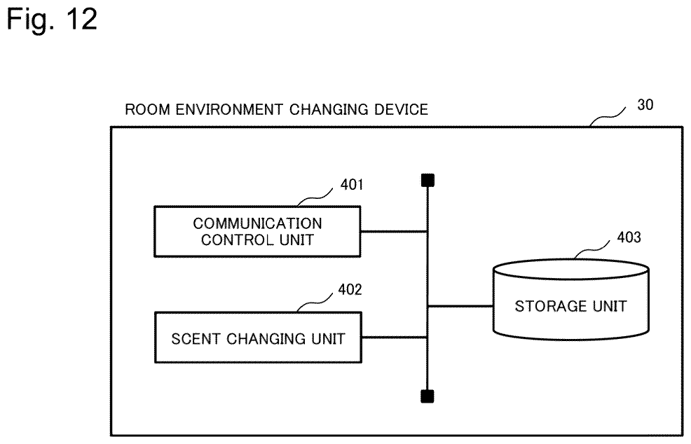

FIG. 12 is a diagram illustrating an example of a processing configuration (processing module) of the room environment changing device 30. Referring to FIG. 12, the room environment changing device 30 includes a communication control unit 401, a scent changing unit 402, and a storage unit 403.

The communication control unit 401 is means configured to control communication with other devices. Specifically, the communication control unit 401 receives data (packet) from the server device 20. Furthermore, the communication control unit 401 transmits data to the server device 20. The communication control unit 401 delivers data received from another device to another processing module. The communication control unit 401 transmits data acquired from another processing module to another device. In this manner, the other processing modules transmit and receive data to and from other devices via the communication control unit 401.

The scent changing unit 402 is means configured to change the scent generated in the room based on an instruction from the server device 20. The scent changing unit 402 controls switches and valves so that a scent designated by the room environment changing instruction is emitted. For example, it is assumed that a first tank contains a first scent component and a second tank contains a second scent component. When the generation of the first scent is instructed from the server device 20, the scent changing unit 402 controls the switch or valve so that the first tank is connected to the outside air, and releases the first scent into the room. Alternatively, the scent changing unit 402 may perform control to apply pressure to a target tank so that a necessary scent fills the conference room quickly.

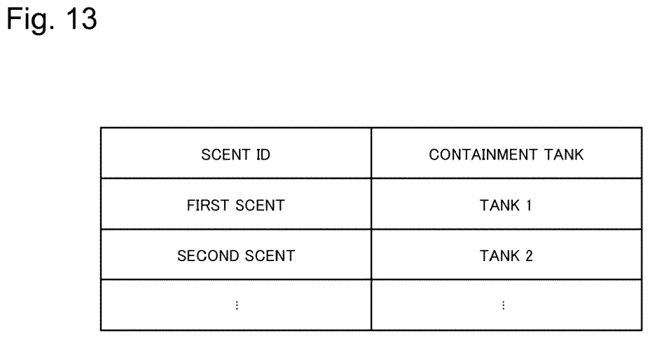

The storage unit 403 is means configured to store information necessary for the operation of the room environment changing device 30. For example, the storage unit 403 stores table information indicating the relationship between the type of scent (scent ID) instructed from the server device 20 and the tank containing each scent (see FIG. 13).

[Operation of Conference Assisting System]

Next, an operation of the conference assisting system according to the first example embodiment will be described.

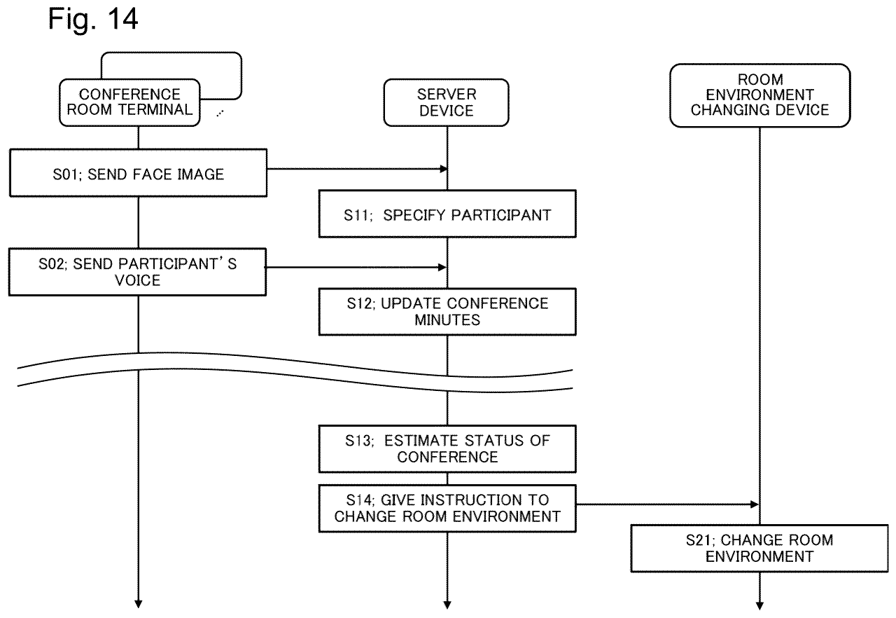

FIG. 14 is a sequence diagram illustrating an example of an operation of a conference assisting system according to the first example embodiment. FIG. 14 is a sequence diagram illustrating an example of a system operation when a conference is actually held. It is assumed that the system user is registered in advance prior to the operation of FIG. 14.

When the participant is seated, the conference room terminal 10 acquires a face image of the seated person and transmits the face image to the server device 20 (step S01). In addition, a representative operates the conference room terminal 10 to notify the server device 20 of the start of the conference.

The server device 20 specifies the participant using the acquired face image (step S11). The server device 20 sets the feature amount calculated from the acquired face image as the feature amount on the matching side and sets the plurality of feature amounts registered in the user database as the feature amount on the registration side, and executes the one-to-N(N is a positive integer, and the same applies hereinafter.) matching. The server device 20 repeats the matching for each participant (the conference room terminal 10 used by the participant) to the conference and generates a participant list.

While the conference is in progress, the conference room terminal acquires voices of the participants and transmits the voices to the server device 20 (step S02). That is, voices of the participants are collected by the conference room terminal 10 and sequentially transmitted to the server device 20.

The server device 20 analyzes the acquired voice (voice file) and extracts a keyword from the utterance of the participant. The server device 20 updates the conference minutes using the extracted keywords and participant IDs (step S12).

While the conference is being held, the processing of steps S02 and S12 is repeated. As a result, a speaker and a main point (keyword) of the utterance of the speaker are added to the conference minutes (simple conference minutes in a table format).

The server device 20 estimates the situation of the conference periodically or at a predetermined timing (step S13).

The server device 20 determines whether to change the room environment based on the estimated conference situation, and transmits a “room environment changing instruction” to the room environment changing device 30 when it is necessary to change the room environment (step S14).

The room environment changing device 30 changes the room environment based on the instruction from the server device 20 (step S21).

As described above, the server device 20 according to the first example embodiment generates the conference minutes in real time and analyzes the generated conference minutes to estimate the situation of the conference. The server device 20 controls the environment of the conference room based on the estimated situation of the conference. For example, when determining that the conference is overheated as a result of estimating the situation of the conference, the server device 100 changes the environment of the conference room so that the participants regain their composure. Alternatively, for example, when determining that the discussion of the conference is stagnant, the server device 20 changes the environment of the conference room so that the participants become active. As a result, constructive discussion will be conducted in the conference. [Second Example Embodiment]

Next, a second example embodiment will be described in detail with reference to the drawings.

In the first example embodiment, the case where the room environment of the conference room is changed based on the situation of the conference (conference success degree) has been described.

In the second example embodiment, a case where the environment of the room (in particular, a break room) is changed during a break time or the like instead of changing the room environment during a conference as in the first example embodiment will be described.

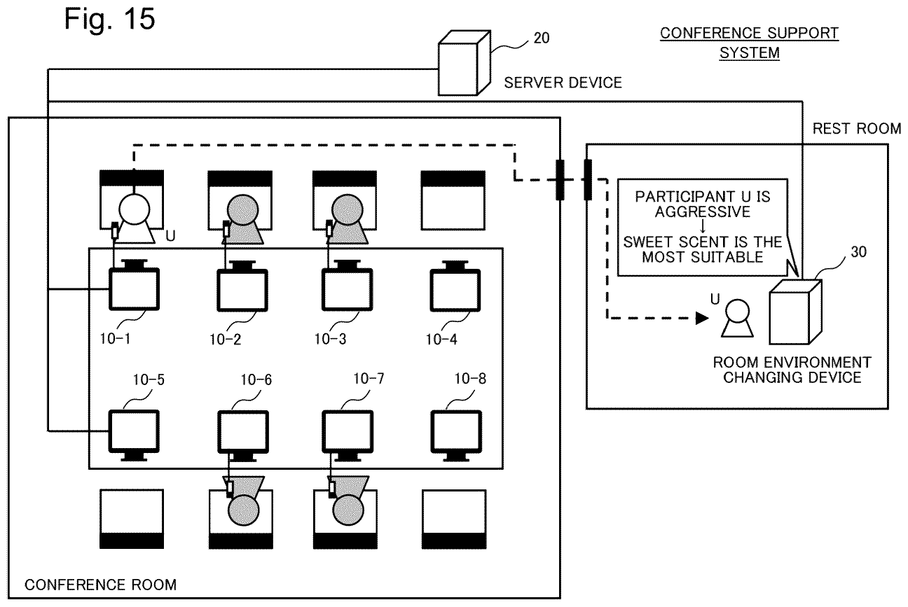

FIG. 15 is a diagram illustrating an example of a schematic configuration of a conference assisting system according to the second example embodiment. As illustrated in FIG. 15, in the conference assisting system according to the second example embodiment, the room environment changing device 30 is installed in a break room.

When a break time of the conference held in the conference room comes, the participants go to the break room. For example, in the example of FIG. 15, a participant U who has used the conference room terminal 10-1 moves to the break room.

The room environment changing device 30 detects that the participant U has entered the break room and acquires the face image (biometric information). The room environment changing device 30 transmits a “room environment determination request” including the acquired face image to the server device 20.

The server device 20 extracts the face image from the acquired room environment determination request, and specifies the user ID of the participant U based on the extracted face image.

The server device 20 analyzes (analysis of personality, way of thinking, and the like of the participant U) the participant U using the specified user ID, and determines an optimal room environment for the participant U. For example, the server device 20 determines a “scent” suitable for the participant U. The environment changed by the room environment changing device 30 is not limited to the “scent”, and may be the brightness, music, or the like in the room.

The concentration and the creativity of the participant U who has experienced the changed room environment are improved. Similarly, for other participants, the concentration and the like are improved by taking a break in the break room. A plurality of break rooms and the room environment changing devices 30 may be prepared, and a plurality of participants may take a break in the same time zone.

As each participant regains their focus, heated discussions take place at the resumed conference. That is, also in the second example embodiment, the server device 20 can assist the conference so that constructive discussion is performed.

Hereinafter, each device included in the conference assisting system according to the second example embodiment will be described. The processing configuration and the like of the conference room terminal according to the second example embodiment can be the same as the processing configuration and the like of the conference room terminal 10 according to the first example embodiment, and thus the description thereof will be omitted. Hereinafter, differences between the first and second example embodiments will be mainly described.

[Server Device]

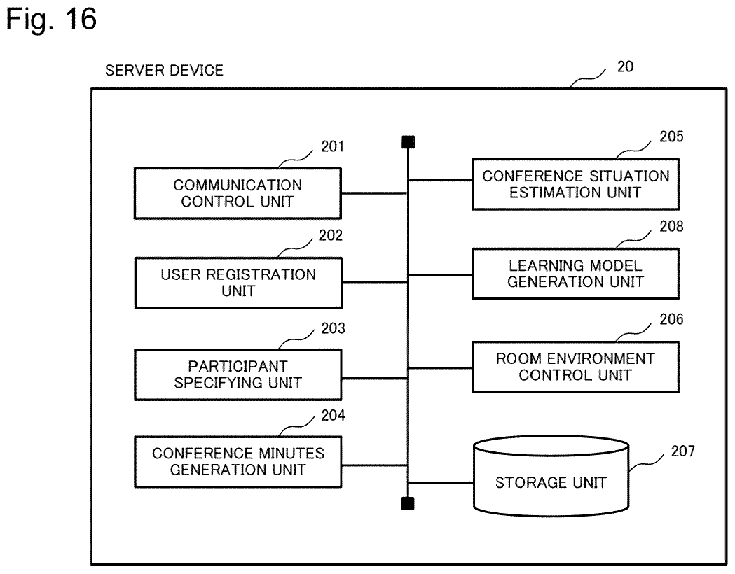

FIG. 16 is a diagram illustrating an example of a processing configuration (processing module) of the server device 20 according to the second example embodiment. Referring to FIG. 16, a learning model generation unit 208 is added to the configuration according to the first example embodiment.

The learning model generation unit 208 is means configured to generate a learning model for determining (outputting) an optimal “scent” for a participant from the utterance (utterance content) of the participant.

The system administrator or the like collects a large number of conference minutes before operating the system. In addition, the administrator or the like causes speakers of utterances described in the conference minutes to smell various types of scents and collects their feelings. For example, a speaker U1 who has uttered the word A is caused to smell a plurality of types of scents (for example, a sweet scent, a fresh scent, and the like). The administrator collects feelings (for example, relaxing, refreshed, increased concentration, or the like) of each scent of the speaker U1.

Similarly, the administrator or the like causes a speaker U2 who has uttered another word B to smell a plurality of types of scents. The administrator collects feelings (change in sensory and change in emotion) of each scent of the speaker U2.

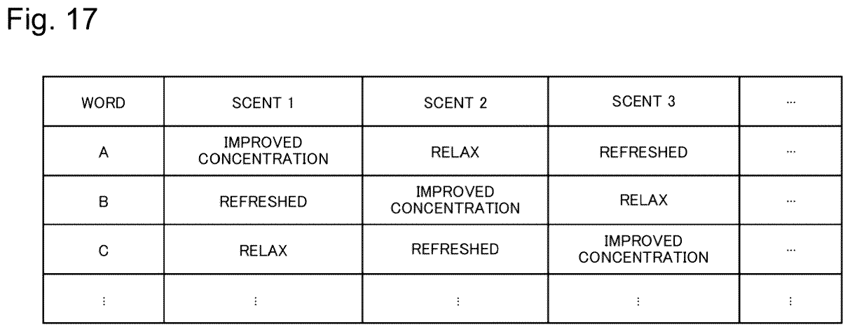

The administrator or the like collects data as illustrated in FIG. 17 by collecting words (utterances at a conference) as described above and feelings of speakers.

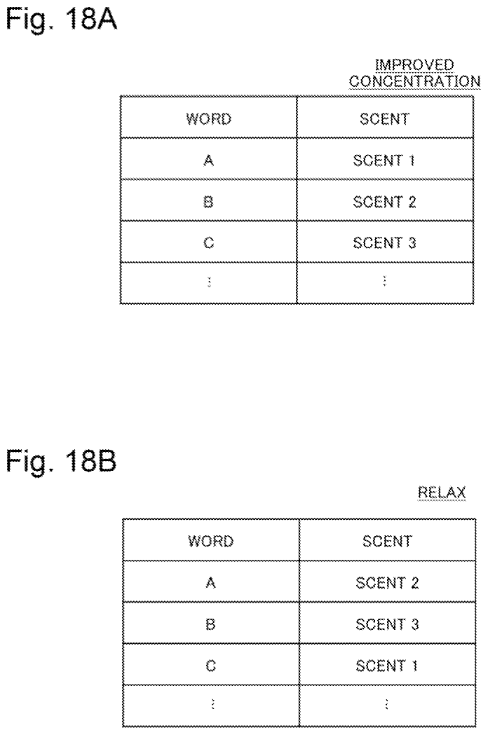

Next, the administrator or the like generates data in which a word and a scent are associated with each feelings for the collected data. For example, the administrator or the like generates data in which a word and a scent are associated with a feeling of “increased concentration”. In this case, data as illustrated in FIG. 18(a) is generated. Alternatively, for a feeling of “relax”, data in which a word and a scent are associated as shown in FIG. 18(b) is generated.

The administrator or the like inputs data as illustrated in FIG. 18 to the server device 20 as learning data (teacher data).

The learning model generation unit 208 of the server device 20 performs machine learning using the acquired learning data and generates a learning model. For example, when acquiring learning data as illustrated in FIG. 18(a), the learning model generation unit 208 generates a learning model for selecting a scent that improves concentration (a scent that improves concentration of a person who has smelled the scent). Alternatively, for example, when acquiring learning data as illustrated in FIG. 18(b), the learning model generation unit 208 generates a learning model for selecting a scent that allows a person who has smelled the scent to relax.

The learning model generation unit 208 performs the machine learning using the above learning data (teacher data; a word labeled scent) to generate a learning model (learning device or classifier). For generation of the learning model by the learning model generation unit 208, any algorithm such as a support vector machine, boosting, or a neural network can be used. A known technique can be used as the algorithm such as the support vector machine, and thus the description thereof will be omitted.

In this manner, the learning model generation unit 208 generates the learning model using the word (keyword) uttered at the conference and the scent (room environment) that causes a specific feeling (for example, concentration can be improved and relaxation can be achieved) to occur to the speaker of the uttered word. The learning model generation unit 208 stores the generated learning model in the storage unit 207.

The room environment control unit 206 determines a scent (room environment) suitable for the user by inputting a word uttered by the user (person on break) to the learning model, and controls the room environment changing device 30 to have the determined scent.

Specifically, when acquiring the “room environment determination request” from the room environment changing device 30, the room environment control unit 206 acquires the face image of the person on break (participant who has moved to the break room) from the request. The room environment control unit 206 delivers the acquired face image to the participant specifying unit 203, and requests the participant specifying unit to specify the user ID of the person on break.

The room environment control unit 206 acquires the user ID (the user ID of the person on break) from the participant specifying unit 203. The room environment control unit 206 refers to the conference minutes (see FIG. 10) generated by the conference minutes generation unit 204, and extracts keywords (words) uttered by the person on break relating to the acquired user ID. The room environment control unit 206 specifies a word of which the number of utterances is largest among words uttered by the person on break. A word of which the number of utterances is large can be understood to clearly indicate the personality and the way of thinking of the person on break.

The room environment control unit 206 inputs the specified word to the learning model, and acquires the “scent” relating to the input word from the learning model.

The room environment control unit 206 transmits a response including the acquired scent ID (response to the room environment determination request) to the room environment changing device 30.

In this manner, the room environment control unit 206 determines words to be input to the learning model based on the conference minutes (conference minutes including words uttered by a person on break). Furthermore, the room environment control unit 206 determines a word to be input to the learning model based on the number of times of utterances of each word uttered by the person on break. In particular, the room environment control unit 206 determines a word that a person on break frequently uttered during the conference as a word to be input to the learning model.

In the second example embodiment, it is desirable to generate conference minutes including a word (keyword) that makes the personality and the way of thinking of the participant (person on break) remarkably appear or generate a learning model. For example, words indicating aggressiveness, such as “try hard” and “do it anyway”, and words indicating passivity such as “but” and “cannot” are exemplified as the above words.

[Room Environment Changing Device]

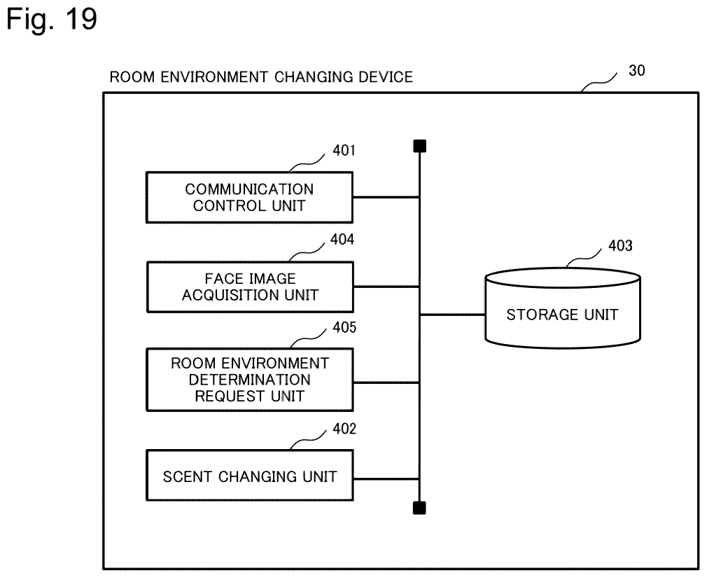

FIG. 19 is a diagram illustrating an example of a processing configuration (processing module) of the room environment changing device 30 according to the second example embodiment. Referring to FIG. 19, in the room environment changing device 30 according to the second example embodiment, a face image acquisition unit 404 and a room environment determination request unit 405 are added to the configuration of the first example embodiment.

The face image acquisition unit 404 acquires biometric information (face image) of the person on break. The operation of the face image acquisition unit 404 can be similar to that of the face image acquisition unit 302 of the conference room terminal 10 described in the first example embodiment, and thus a detailed description thereof will be omitted.

When acquiring the face image, the face image acquisition unit 404 delivers the face image to the room environment determination request unit 405.

The room environment determination request unit 405 transmits a “room environment determination request” including the acquired face image to the server device 20.

The room environment determination request unit 405 acquires the response (the response including the scent ID) from the server device 20. The room environment determination request unit 405 extracts the scent ID from the response and delivers the scent ID to the scent changing unit 402.

The scent changing unit 402 generates a scent relating to the scent ID (generates a scent instructed by the server device 20).

[Operation of Conference Assisting System]

Next, an operation of the conference assisting system according to the second example embodiment will be described.

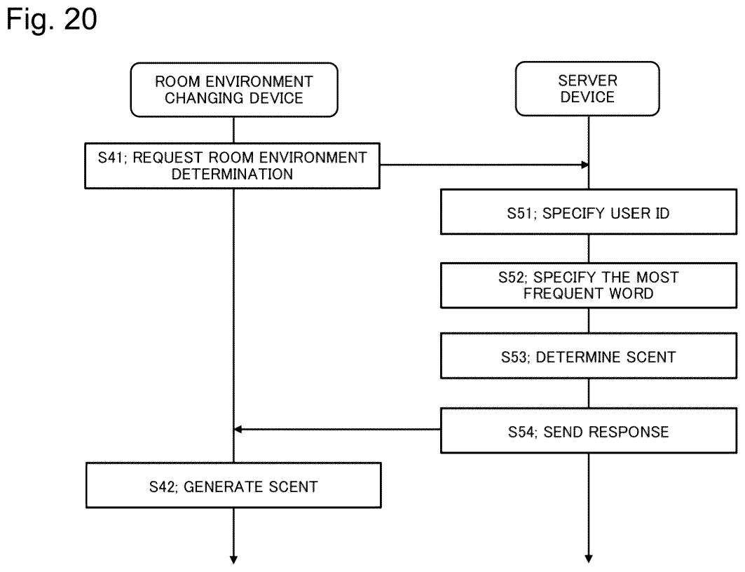

FIG. 20 is a sequence diagram illustrating an example of an operation of a conference assisting system according to the second example embodiment. FIG. 20 is a sequence diagram illustrating an example of a system operation when a conference is actually held. Prior to the operation of FIG. 20, it is assumed that the conference minutes and the learning model are generated in advance.

The room environment changing device 30 transmits the room environment determination request including the face image of the person on break to the server device 20 (step S41).

The server device 20 specifies the user ID of the person on break by the matching processing using the acquired face image (step S51).

The server device 20 specifies a word (keyword) of which the number of utterances is largest among the utterances of the specified user ID (step S52).

The server device 20 inputs the specified word to the learning model and determines a scent suitable for a visitor (step S53).

The server device 20 transmits a response including the determined scent ID to the room environment changing device 30 (step S54).

The room environment changing device 30 generates a scent relating to the acquired scent ID (step S42).

The server device 20 may generate a learning model for each of the plurality of feelings. That is, the storage unit 207 may store a plurality of learning models. Furthermore, the server device 20 may use the plurality of learning models properly.

For example, in a case where it is determined that the conference is stagnant from the conference success degree, the server device 20 uses the learning model related to “improved concentration” and selects an optimum scent for the person on break. Alternatively, in a case where it is determined that the conference is overheated from the conference success degree, the server device 20 uses the learning model related to “relax” and selects an optimum scent for the person on break. As described above, the room environment control unit 206 according to the second example embodiment may select the learning model to which the word uttered by the person on break is input among the plurality of learning models based on the estimated situation of the conference (conference success degree).

Alternatively, in a case where the server device 20 according to the second example embodiment determines that the situation of the conference is stagnant, the server device may recommend the participants of the conference to take a break. When it is determined by the server device 20 that the conference is stagnant, each participant recovers concentration by taking a break, and constructive discussion is performed.

As described above, in the conference assisting system according to the second example embodiment, the participants of the conference move to the break room (alternatively, a private room such as an aroma station) during the break time. In the break room, a person on break is specified, and the server device 20 analyzes a personality, a way of thinking, and the like of the specified person on break. Specifically, the server device 20 inputs a word (a word most clearly representing the feature of the person on break) uttered by the person on break to the learning model prepared in advance, and selects a scent suitable for the person on break. The room environment changing device 30 generates a scent selected by the server device 20. A person on break who has sniffed the scent can improve his/her concentration and creativity, and a discussion that is naturally heated is started in a conference resumed after the break.

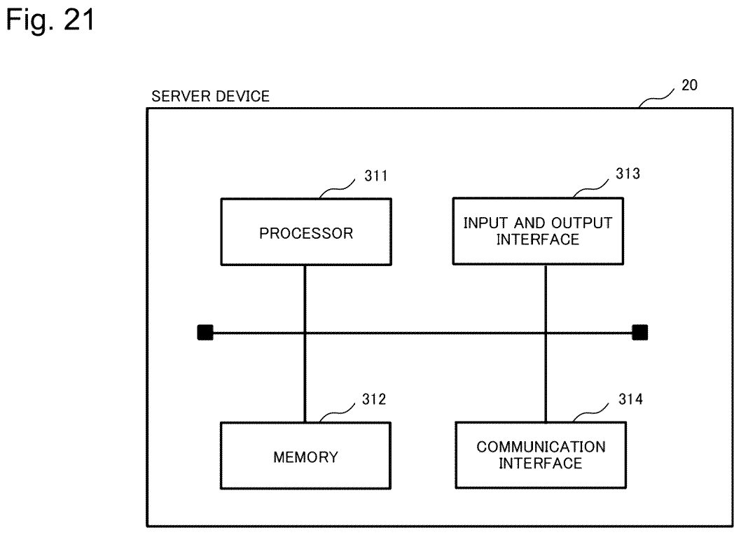

Next, hardware of each device constituting the conference assisting system will be described. FIG. 21 is a diagram illustrating an example of a hardware configuration of the server device 20.

The server device 20 can be configured by an information processing device (so-called computer), and has the configuration illustrated in FIG. 21. For example, the server device 20 includes a processor 311, a memory 312, an input and output interface 313, a communication interface 314, and the like. The components such as the processor 311 are connected by an internal bus or the like, and are configured to be able to communicate with each other.

However, the configuration illustrated in FIG. 21 is not intended to limit the hardware configuration of the server device 20. The server device 20 may include hardware (not illustrated) or may not include the input and output interface 313 as necessary. In addition, the number of processors 311 and the like included in the server device 20 is not limited to the example of FIG. 21, and for example, a plurality of processors 311 may be included in the server device 20.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various data items.

The input and output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with other devices. For example, the communication interface 314 includes a network interface card (NIC) or the like.

The functions of the server device 20 are implemented by various processing modules. The processing module is implemented, for example, by the processor 311 executing a program stored in the memory 312. Furthermore, the program can be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. Furthermore, the program can be downloaded via a network or updated using a storage medium storing the program. Further, the processing module may be achieved by a semiconductor chip.

The conference room terminal 10 can also be configured by an information processing device similarly to the server device 20, and since there is no difference in the basic hardware configuration from the server device 20, the description thereof will be omitted. The conference room terminal 10 may include a camera and a microphone, or may be configured to be connectable with a camera and a microphone. Also, regarding the room environment changing device 30, an existing (general-purpose) “scent generation device” may be provided with a communication function or the like and it is clear for a person skilled in the art, and thus the description regarding the hardware of the device will be omitted. In addition, the room environment changing device 30 according to the second example embodiment includes a camera.

The server device 20 is equipped with a computer, and the function of the server device 20 can be achieved by causing the computer to execute a program. In addition, the server device 20 executes the conference assisting method by the program.

### Modification Example

The configuration, operation, and the like of the conference assisting system described in the above example embodiment are merely examples, and are not intended to limit the configuration and the like of the system.

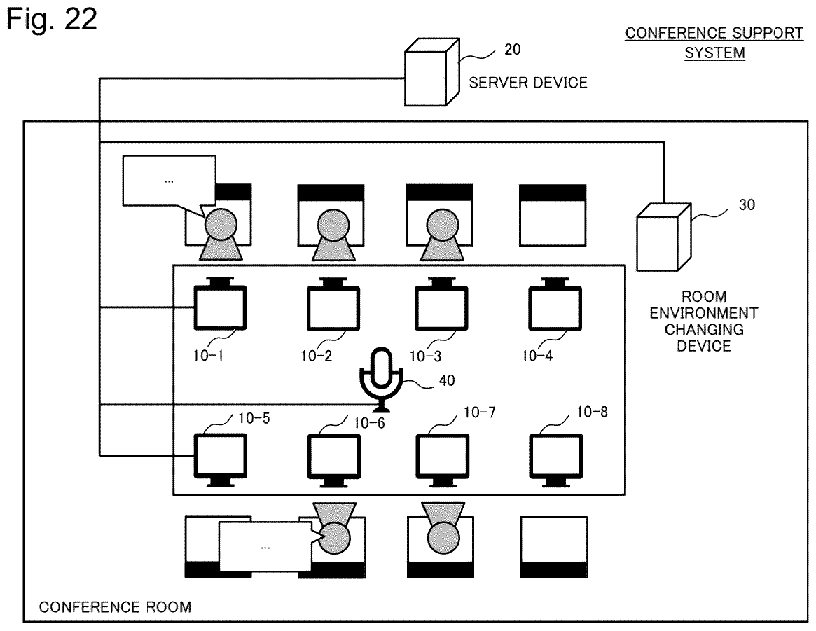

In the above example embodiment, a microphone is connected to the conference room terminal 10, and a speaker is specified by the ID of the conference room terminal 10 that transmits a voice. However, as illustrated in FIG. 22, one microphone 40 may be installed at a desk, and the microphone 40 may collect utterances of each participant. In this case, the server device 20 may execute “speaker identification” on the voice collected from the microphone 40 to specify the speaker.

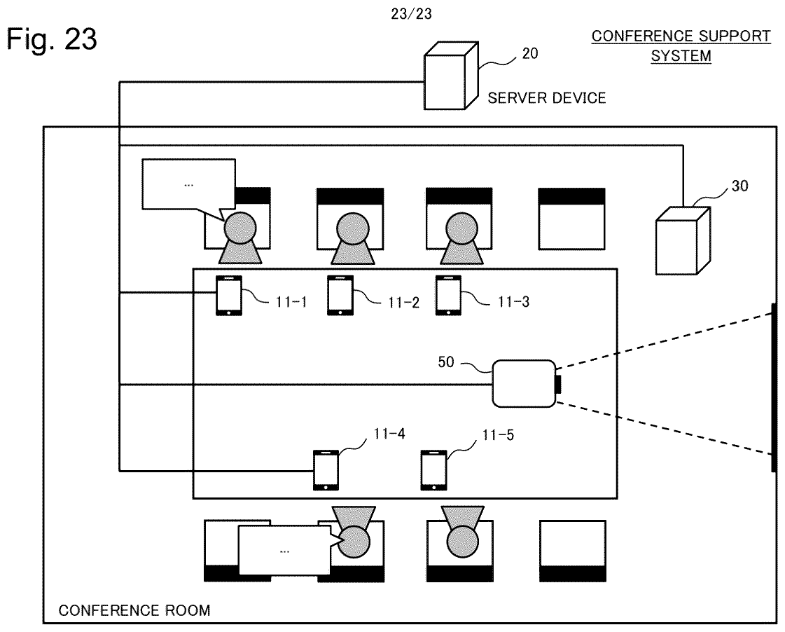

In the above example embodiment, the case where the dedicated conference room terminal 10 is installed on the desk has been described, but the function of the conference room terminal 10 may be achieved by a terminal possessed (possessed) by the participant. For example, as illustrated in FIG. 23, each of the participants may participate in the conference by using terminals 11-1 to 11-5. The participant operates his/her terminal 11 and transmits his/her face image to the server device at the start of the conference. Furthermore, the terminal 11 transmits the voice of the participant to the server device 20. The server device may provide an image, a video, or the like to the participant using a projector 50.

The profile of the system user (attribute value of the user) may be input using a scanner or the like. For example, the user inputs an image related to his/her business card to the server device 20 using a scanner. The server device 20 executes optical character recognition (OCR) processing on the acquired image. The server device 20 may determine the profile of the user based on the obtained information.

In the above example embodiment, the case where the biometric information related to the “face image” is transmitted from the conference room terminal 10 to the server device 20 has been described. However, the biometric information related to “the feature amount generated from the face image” may be transmitted from the conference room terminal 10 to the server device 20. The server device 20 may execute the matching processing with the feature amount registered in the user database using the acquired feature amount (feature vector).

In the above example embodiment, the case where the server device 20 transmits the “room environment changing instruction” to room environment changing device 30 has been described. However, the “conference success degree” may be transmitted from the server device 20 to the room environment changing device 30. In this case, the room environment changing device 30 may select the scent to be generated based on the acquired conference success degree.

The room environment changing device 30 may rotate a fan or the like when generating the scent instructed from the server device 20. By rotating the fan or the like, the room is quickly filled with the scent.

The server device 20 may instruct the room environment changing device 30 to change the brightness or the music to be played, or the like in the room instead of the “scent” or in addition to the “scent”. The room environment changing device 30 may change at least one of a scent generated in the conference room, brightness of the conference room, and music to be played in the conference room. Regarding the change in the brightness of the room and the change in the music to be played by the room environment changing device 30, it is obvious for those of ordinary skill in the art to achieve these changes, and thus a detailed description thereof will be omitted. For example, the room environment changing device 30 may control the brightness of the room by controlling voltage, current, and the like applied to a light emitting diode (LED). Further, the room environment changing device 30 may change the music to be played in the conference room by reproducing a music file prepared in advance from the speaker.

In the second example embodiment, the case where the room environment changing device 30 is installed in a room different from the conference room has been described, but it is a matter of course that the device may be installed in the conference room. For example, the room environment changing device 30 may be placed in a corner of a conference room.

In the flow chart (flowchart and sequence diagram) used in the above description, a plurality of steps (processing) are described in order, but the execution order of the steps executed in the example embodiment is not limited to the described order. In the example embodiment, for example, the order of the illustrated steps can be changed within a range in which there is no problem in terms of content, such as executing each process in parallel.

The above example embodiments have been described in detail in order to facilitate understanding of the present disclosure, and it is not intended that all the configurations described above are necessary. In addition, in a case where a plurality of example embodiments has been described, each example embodiment may be used alone or in combination. For example, a part of the configuration of the example embodiment can be replaced with the configuration of another example embodiment, or the configuration of another example embodiment can be added to the configuration of the example embodiment. Furthermore, it is possible to add, delete, and replace other configurations for a part of the configuration of the example embodiment.

Although the industrial applicability of the present invention is apparent from the above description, the present invention can be suitably applied to a system or the like that assists with a conference or the like held by a company or the like.

Some or all of the above-described example embodiments may be described as in the following supplementary notes, but are not limited to the following.

[Supplementary Note 1]

A server device including:
a storage unit that stores a learning model generated by using a word uttered at a conference and a room environment that causes a speaker of the uttered word to have a specific feeling; and
an environment control unit that determines a room environment suitable for a user by inputting a word uttered by the user to the learning model and controls a room environment changing device to change the room environment to the determined room environment.

[Supplementary Note 2]

The server device according to Supplementary Note 1, further including:
a learning model generation unit that generates the learning model.

[Supplementary Note 3]

The server device according to Supplementary Note 1 or 2, further including:
an estimation unit that estimates a situation of a conference,
in which the storage unit stores a plurality of the learning models, and
the environment control unit selects a learning model to which a word uttered by the user is input among the plurality of learning models based on the estimated situation of the conference.

[Supplementary Note 4]

The server device according to Supplementary Note 3, in which the estimation unit calculates a conference success degree indicating a degree of success of a conference and estimates a situation of the conference based on the calculated conference success degree.

[Supplementary Note 5] The server device according to any one of Supplementary Notes 1 to 4, further including:
a conference minutes generation unit that generates conference minutes including a word uttered by the user,
in which the environment control unit determines a word to be input to the learning model based on the conference minutes.

[Supplementary Note 6]

The server device according to Supplementary Note 5, in which the environment control unit determines a word to be input to the learning model based on a number of times each word is uttered by the user.

[Supplementary Note 7]

The server device according to any one of Supplementary Notes 1 to 6, in which the room environment changing device changes at least one of a scent generated in the conference room, brightness of the conference room, and music to be played in the conference room.

[Supplementary Note 8]

A conference assisting system including:
a room environment changing device configured to change a room environment; and
a server device connected to the room environment changing device,
wherein the server device includes
a storage unit that stores a learning model generated by using a word uttered at a conference and a room environment that causes a speaker of the uttered word to have a specific feeling, and
an environment control unit that determines a room environment suitable for a user by inputting a word uttered by the user to the learning model and controls a room environment changing device to change the room environment to the determined room environment.

[Supplementary Note 9]

A conference assisting method performed by a server device, the method including:
storing a learning model generated by using a word uttered at a conference and a room environment that causes a speaker of the uttered word to have a specific feeling; and
determining a room environment suitable for a user by inputting a word uttered by the user to the learning model and controlling a room environment changing device to change the room environment to the determined room environment.

[Supplementary Note 10]

A computer readable storage medium that stores a program for causing a computer mounted on a server device to execute:
a process for storing a learning model generated by using a word uttered at a conference and a room environment that causes a speaker of the uttered word to have a specific feeling; and
a process for determining a room environment suitable for a user by inputting a word uttered by the user to the learning model and controlling a room environment changing device to change the room environment to the determined room environment.

[Supplementary Note 11]

A server device including:
an estimation unit that estimates a situation of the conference; and
an environment control unit that controls a room environment of a conference room based on the estimated situation of the conference.

[Supplementary Note 12]

The server device according to Supplementary Note 11, in which
the estimation unit calculates a conference success degree indicating a degree of success of a conference and estimates a situation of the conference based on the calculated conference success degree.

[Supplementary Note 13]

The server device processing according to Supplementary Note 12, further including:
a conference minutes generation unit that generates conference minutes,
in which the estimation unit calculates the conference success degree by analyzing the generated conference minutes.

[Supplementary Note 14]

The server device according to Supplementary Note 13, in which the estimation unit calculates the conference success degree based on the number of times of speaking of a participant in a predetermined period.

[Supplementary Note 15]

The server device according to Supplementary Note 13 or 14, in which the estimation unit calculates the conference success degree based on the number of speakers in a predetermined period.

[Supplementary Note 16]

The server device according to any one of Supplementary Notes 13 to 15, in which the estimation unit calculates the conference success degree based on an interval from a utterance of one participant to a utterance of another participant.

[Supplementary Note 17]

The server device according to any one of Supplementary Notes 12 to 16, in which the estimation unit performs statistical processing on the conference success degree calculated by a different method, and estimates a situation of the conference based on a result of the statistical processing.

[Supplementary Note 18]

The server device according to any one of Supplementary Notes 11 to 17, in which the environment control unit instructs a room environment changing device for changing an environment of a conference room to change the room environment of the conference room.

[Supplementary Note 19]

The server device according to Supplementary Note 18, in which the room environment changing device changes at least one of a scent generated in the conference room, brightness of the conference room, and music to be played in the conference room.

[Supplementary Note 20]

A conference assisting system including:
a room environment changing device that changes an environment of a conference room; and
a server device;
in which the server device includes
an estimation unit that estimates a situation of the conference, and
an environment control unit that controls a room environment of a conference room based on the estimated situation of the conference, and
the environment control unit instructs the room environment changing device to change a room environment of the conference room.

[Supplementary Note 21]

A conference assisting method performed by a server device, the method including:
estimating a situation of the conference; and
controlling a room environment of a conference room based on the estimated situation of the conference.

[Supplementary Note 22]

A computer readable storage medium that stores a program for causing a computer mounted on a server device to execute:
a process for estimating a situation of a conference; and
a process for controlling a room environment of a conference room based on the estimated situation of conference.

The disclosures of the cited prior art documents are incorporated herein by reference. Although the example embodiments of the present invention have been described above, the present invention is not limited to these example embodiments. It will be understood by those of ordinary skill in the art that these example embodiments are exemplary only and that various variations are possible without departing from the scope and spirit of the invention. That is, it goes without saying that the present invention includes various modifications and corrections that can be made by those of ordinary skill in the art in accordance with the entire disclosure including the claims and the technical idea.

### REFERENCE SIGNS LIST

10, 10-1 to 10-8 conference room terminal
11, 11-1 to 11-5 terminal
20, 100 server device
room environment changing device
microphone
50 projector
101, 207, 304, 403 storage unit
102 environment control unit
201, 301, 401 communication control unit
202 user registration unit
203 participant specifying unit
204 conference minutes generation unit
205 conference situation estimation unit
206 room environment control unit
208 learning model generation unit
211 user information acquiring unit
212 ID generation unit
213 feature amount generation unit
214, 224 entry management unit
221 voice acquisition unit
222 text conversion unit
223 keyword extraction unit
302, 404 face image acquisition unit
303 voice transmission unit
311 processor
312 memory
313 input and output interface
314 communication interface
402 scent changing unit
405 room environment determination request unit

What is claimed is:

1. A server device comprising:
a memory storing a learning model generated by using a word uttered at a conference and a room environment that causes a speaker of the uttered word to have a specific feeling; and
at least one processor coupled to the memory
the at least one processor performing operations to:
determine a room environment suitable for a user by inputting a word uttered by the user to the learning model and
control a room environment changing device to change the room environment to the determined room environment.

2. The server device according to claim 1, wherein the at least one processor further performs operation to:
generate the learning model.

3. The server device according to claim 1, wherein
the memory stores a plurality of the learning models and
the at least one processor further performs operation to:
estimate a situation of a conference, and
select a learning model to which a word uttered by the user is input among the plurality of learning models based on the estimated situation of the conference.

4. The server device according to claim 3, wherein the at least one processor further performs operation to:
calculate a conference success degree indicating a degree of success of a conference and
estimate a situation of the conference based on the calculated conference success degree.

5. The server device according to claim 1, wherein the at least one processor further performs operation to:
generate conference minutes including a word uttered by the user,
determine a word to be input to the learning model based on the conference minutes.

6. The server device according to claim 5, wherein the at least one processor further performs operation to:
determine a word to be input to the learning model based on a number of times each word is uttered by the user.

7. The server device according to claim 1, wherein the at least one processor further performs operation to:
change at least one of a scent generated in the conference room, brightness of the conference room, and music to be played in the conference room.

8. (canceled)

9. A conference assisting method performed by a server device, the method comprising:
storing a learning model generated by using a word uttered at a conference and a room environment that causes a speaker of the uttered word to have a specific feeling; and
determining a room environment suitable for a user by inputting a word uttered by the user to the learning model and controlling a room environment changing device to change the room environment to the determined room environment.

10. A non-transitory computer readable storage medium that stores a program for causing a computer mounted on a server device to execute:
storing a learning model generated by using a word uttered at a conference and a room environment that causes a speaker of the uttered word to have a specific feeling; and
determining a room environment suitable for a user by inputting a word uttered by the user to the learning model and controlling a room environment changing device to change the room environment to the determined room environment.
